(19) United States
(12) Patent Application Publication
(10) Pub. No.: US 2006/0263707 A1
(43) Pub. Date: Nov. 23, 2006

(54) Image forming apparatus

(75) Inventor: Shinichi Shikii, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/415,103

(22) Filed: May 2, 2006

(30) Foreign Application Priority Data
May 2, 2005 (JP) P.2005-134300

(51) Int. Cl. G03C 5/00

(52) U.S. Cl. 430/30

(57) ABSTRACT

An image forming apparatus for recording of a target image onto a photosensitive material film corresponding to the photosensitive material film, includes: storage section that stores the data corresponding to the photosensitive material film; density measuring section that measures a density of a density test pattern recorded on the photosensitive material film; and controlling section that controls recording the density test pattern onto the photosensitive material film, and determines the photosensitive material film on the basis of a measurement value of the density of the density test pattern measured by the density measuring section, and controls reading out data corresponding to the photosensitive material film from the storage section, and recording the target image onto the photosensitive material film.

### BACKGROUND OF THE INVENTION

1. Field of the Invention

The present invention relates to an image forming apparatus for recording an image onto a photosensitive material film by using a light beam such as a laser beam and, in particular, to an improved technique for determining the photosensitive material film when the photosensitive material film to be used is changed.

2. Background Art

In recent years, computer assisted diagnosis apparatuses such as a CT (Computed Tomography) apparatus, a CR (Computed Radiography) apparatus, and an MRI (Magnetic Resonance Imaging) apparatus are widely used in medical fields. For example, an image forming apparatus for recording a medical-use image such as an X-ray image and a CT image employs a light beam irradiation device such as a laser diode and a semiconductor laser device, then scans a photosensitive material film with a light beam, thereby forms in the photosensitive material film a latent image corresponding to the image, and then performs thermal development on this film.

Meanwhile, in such an image forming apparatus, depending on the type of the radiation image information, the size of the image, and the like, a film that has optimum sensitivity characteristics or size needs to be selected for recording the radiation image information. As for such photosensitive materials used in the photosensitive material films, improvement is achieved day by day. Thus, a large variety of photosensitive material films can be used in such an image forming apparatus. For example, in JP-A-2004-163529 (the term “JP-A” as used herein refers to an “unexamined published Japanese patent application”), an example is described that various photosensitive material films are used in the same image forming apparatus.

When an image is to be recorded onto a photosensitive material film, in a case that the photosensitive material employed in the photosensitive material film is changed, recording density obtained after the thermal development and the like can vary even when the same image is recorded at the same exposure value. Thus, when the photosensitive material film is changed, a information corresponding to the photosensitive material film needs to be set up into the image forming apparatus so that various kinds of correction coefficients needs to be changed in accordance with the photosensitive material film.

An image forming apparatus of a certain model reads a bar code stuck on a film package or the like, and thereby determines automatically the photosensitive material film. Nevertheless, this image forming apparatus is required to be provided with reading section, and hence causes complexity in the configuration and an increase in the apparatus cost. In contrast, in the case of an image forming apparatus not having such an automatic determination function, a serviceman or a user needs to set up by oneself the photosensitive material film into the image forming apparatus. This work requires skill, and is difficult as well.

### SUMMARY OF THE INVENTION

The present invention has been devised in view of the above-mentioned situation. An object of the present invention is to provide an image forming apparatus employing a simple configuration in which when the photosensitive material film is changed, various kinds of correction coefficients can be changed automatically by determining the photosensitive material film, and thereby to achieve easy film change and reduction in the apparatus cost.

An image forming apparatus is characterized by an image forming apparatus for recording of a target image (hereinafter also referred to as a “recording target image”) onto a photosensitive material film on the basis of a data corresponding to the photosensitive material film, comprising: storage section that stores the data corresponding to the photosensitive material film; density measuring section that measures a density of a density test pattern recorded on the photosensitive material film; and controlling section that controls recording the density test pattern onto the photosensitive material film, and determines the photosensitive material film on the basis of a measurement value of the density of the density test pattern, the measurement value measured by the density measuring section, and controls reading out the data corresponding to the photosensitive material film from the storage section, and then recording the target image onto the photosensitive material film.

In this image forming apparatus, the density test pattern is recorded onto the photosensitive material film. Then, the density of the density test pattern is measured by the density measuring section. The controlling section specifies the photosensitive material film having a storage data corresponding to density, the storage data agreeing with the measurement data. That is, the image forming apparatus automatically determines the photosensitive material film by means of the density test pattern. Thus, a user or a serviceman needs not set up the photosensitive material film into the image forming apparatus at each time. Further, an additional member such as bar code reading section is unnecessary.

An image forming apparatus is characterized in that the data is at least one selected from: calibration coefficient data for the density measuring section; sharpness correction coefficient data to be applied when sharpness correction is performed on the target image; uniformity correction coefficient data to be applied when uniformity correction (hereinafter also referred to as a “exposure value correction”) is performed on the target image; density correction data to be applied when density correction is performed on the target image; and heating data to be applied when thermal development is performed on the photosensitive material film in which the target image is recorded as a latent image.

In this image forming apparatus, after the controlling section automatically determines the photosensitive material film on the basis of the density test pattern, at least one selected from the calibration coefficient data, the sharpness correction coefficient data, the uniformity correction coefficient data, the density correction data, and the heating data corresponding to the photosensitive material film is read out from the storage section. Then, on the basis of this data, the recording target image is recorded onto the photosensitive material film.

An image forming apparatus is characterized in that the measurement value is at least one selected from: a maximum density, a minimum density, a necessary energy for a density, and a energy difference between a first energy for a density and a second energy for a density, which are measured from the density test pattern by the density measuring section.

In this image forming apparatus, when the controlling section determines the photosensitive material film, at least one measurement value selected from the maximum density, the minimum density, a necessary energy for a density, and a energy difference between a first energy for a density and a second energy for a density is applied as the determination condition. Here, when the measurement value of the maximum density or the minimum density is applied, determination becomes easy for a photosensitive material film having remarkable density characteristics at the maximum or minimum limit density. Further, when the necessary energy for the density is applied, determination becomes easy for a photosensitive material film having remarkable density characteristics at medium density. Furthermore, when the energy difference between the first energy for the density and the second energy for the density is applied, determination becomes easy for a photosensitive material film having remarkable density characteristics in a predetermined density range.

According to the image forming apparatus of the present invention, provided are: storage section that stores the data corresponding to the photosensitive material film; density measuring section that measures a density of a density test pattern recorded on the photosensitive material film; and controlling section that controls recording the density test pattern onto the photosensitive material film, and determines the photosensitive material film on the basis of a measurement value of the density test pattern, the measurement value measured by the density measuring section, and controls reading out data corresponding to the photosensitive material film from the storage section, and then recording the target image onto the photosensitive material film. Thus, by means of the density test pattern recorded on the photosensitive material film, the image forming apparatus automatically determines the photosensitive material film. Thus, the time and effort are avoided that a user or a serviceman sets up the photosensitive material film into the image forming apparatus at each time. Thus, even when the photosensitive material film is changed, a high quality image can be obtained easily. Further, an additional member such as bar code reading section is unnecessary. Thus, a simple configuration can determine the photosensitive material film.

### BRIEF DESCRIPTION OF THE DRAWINGS

The invention disclosed herein will be understood better with reference to the following drawings of which:

FIG. 1 is a sectional view illustrated configuration of an image forming apparatus according to the present invention;

FIG. 2 is an external appearance perspective view illustrated an image forming apparatus shown in FIG. 1, where a sorter mechanism is omitted;

FIG. 3 is a block configuration diagram illustrated a control system of an image forming apparatus;

FIG. 4 is a flow chart showing an automatic film determination procedure performed by a control section when the photosensitive material film is changed;

FIG. 5 is a diagram showing a conceptual example of a density test pattern; and

FIG. 6 is a graph showing correlation between the density value and the exposure intensity for each photosensitive material.

### DETAILED DESCRIPTION OF THE INVENTION

Exemplary embodiments of the image forming apparatus according to the present invention are described below with reference to the drawings. However, it is to be understood that the invention is not intended to be limited to the specific embodiments.

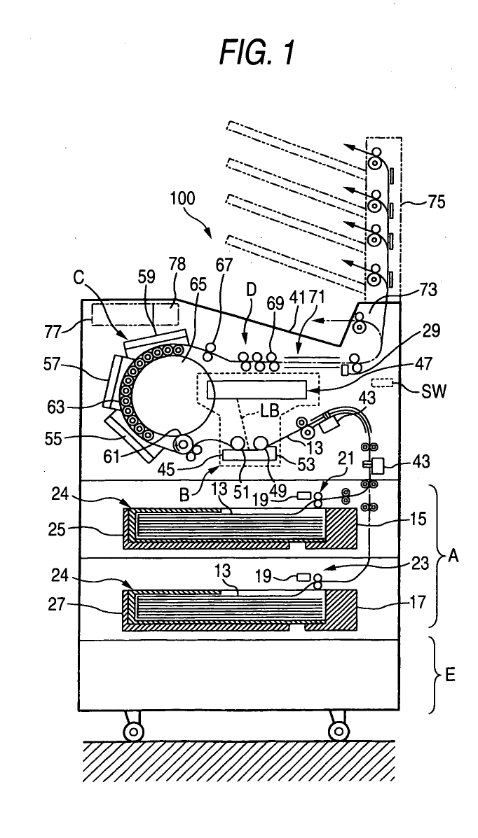

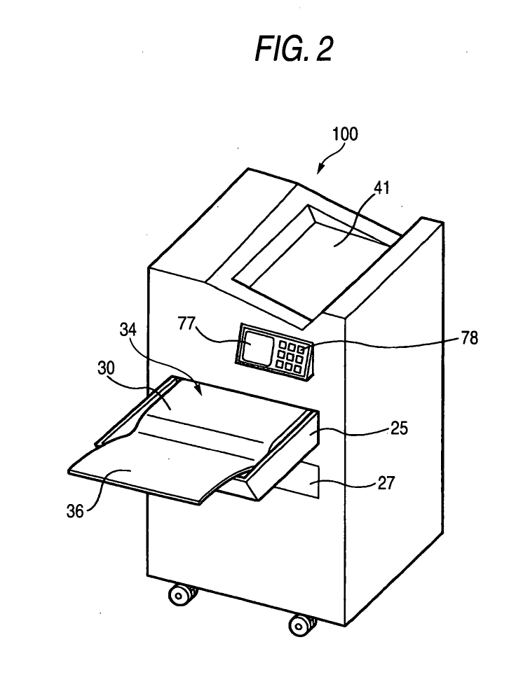

FIG. 1 is a sectional view illustrated configuration of an image forming apparatus according to the present invention. FIG. 2 is an external appearance perspective view illustrated an image forming apparatus shown in FIG. 1, where a sorter mechanism is omitted.

An image forming apparatus 100 includes a photosensitive material film feed section A, an image exposure section B, a thermal development section C, and a cooling section D in the order of the conveyance direction of a sheet shaped photosensitive material film 13. The image forming apparatus 100 further includes: conveying section provided at major points between these sections and conveying the photosensitive material film 13; and a power supply/control section E serving as controlling section for driving and controlling these sections.

Further, the image forming apparatus 100 has a configuration that: the power supply/control section E is arranged at the lowermost level; the photosensitive material film feed section A is arranged thereon; and the image exposure section B, the thermal development section C, and the cooling section D are arranged thereon. The image exposure section B and the thermal development section C are arranged at adjacent positions to each other. This allows an exposure process and a thermal development process to be performed within a short conveyance distance. That is, the conveyance pass length of the photosensitive material film 13 is minimized so that the output time per one sheet can be reduced. Further, both processes of the exposure process and the thermal development process can simultaneously be performed on a single sheet of the photosensitive material film 13.

Employable photosensitive material films 13 include one of a thermal development photosensitive material and a photosensitive thermal recording material. The thermal development photosensitive material is a recording material in which an image is recorded (exposed) by using a light beam (e.g., a laser beam LB) and then thermal development is performed so that the image is converted into visible color. Further, the photosensitive thermal recording material is a recording material in which an image is recorded by using a light beam and then thermal development is performed so that the image is changed into visible color, or alternatively in which a heat mode (heat) of a laser beam LB is used so that recording of an image and conversion into visible color are performed simultaneously and then fixing is performed by means of light irradiation.

The photosensitive material film feed section A is a section for extracting photosensitive material film 13 one sheet at a time, and then feeding the sheet to the image exposure section B located in the downstream in the conveyance direction of the photosensitive material film 13. The photosensitive material film feed section A includes, for example: two loading sections 15 and 17; single-sheet mechanisms 19, and feed roller pairs 21 and 23 each arranged at each loading section; and conveyance rollers and conveyance guides (not shown). Further, in the inside of the loading sections 15 and 17 stacked on each other, film magazines 24 and 24 for the image forming apparatus respectively accommodating photosensitive material films 13 and 13 having different sizes such as the B4 size and the half cut size are inserted respectively into trays 25 and 27 serving as magazine receptacles. Thus, the photosensitive material films 13 and 13 of the sizes or the directions loaded in the respective rows can be used selectively.

The photosensitive material films 13 are cut into a sheet shaped, and packed usually in the form of a stack (bundle) comprising a predetermined unit such as 150 sheets in a light shielding bag 30 composed of an aluminum foil or the like shown in FIG. 2. Thus, the photosensitive material films 13 are treated as a film package 34 containing a predetermined number of sheets. Then, when a cut is formed in a part of the light shielding bag 30 and then a fin part 36 formed at an edge is extracted from the magazine 24, a photosensitive material film 13 is arranged inside the magazine 24. In such a state, the photosensitive material films 13 are loaded at each column of the photosensitive material film feed section A.

The image exposure section B performs scanning exposure of a light beam LB in the main scanning direction onto the photosensitive material film 13 conveyed from the photosensitive material film feed section A. Further, the photosensitive material film 13 is conveyed in the sub-scanning direction (i.e., the conveyance direction) approximately perpendicular to the main scanning direction, so that a desired image is recorded onto the photosensitive material film 13 so that a latent image is formed.

In a state that the photosensitive material film 13 after the scanning exposure is being conveyed, the thermal development section C performs temperature raising processing and thereby achieves thermal development. Then, the cooling section D cools down the photosensitive material film 13 after the development processing. Then, the photosensitive material film 13 is conveyed to the ejection tray 41.

Here, a side edge alignment mechanism 43 is provided in the conveyance path between the photosensitive material film feed section A and the image exposure section B. Then, the photosensitive material film 13 conveyed from the photosensitive material film feed section A is fed to the image exposure section B in a state that the width direction edges are aligned.

Next, the image exposure section B is described in detail.

The image exposure section B is a section for performing exposure onto the photosensitive material film 13 by light beam scanning exposure, and includes: a sub-scanning conveyance section (sub-scanning section) 45 provided with a lift-up preventing mechanism for conveying the thermal development material in a state that lift-up from the conveyance surface is prevented; and a scanning exposure section (laser irradiation section) 47. The scanning exposure section 47 scans the laser (main scanning) in such a manner that the output of the laser is controlled in accordance with image data prepared separately. At that time, the photosensitive material film 13 is moved in the sub-scanning direction by the sub-scanning conveyance section 45.

The sub-scanning conveyance section 45 includes: two driving rollers 49 and 51 which are arranged across the main scanning line of irradiation laser light, and axis thereof are arranged approximately parallel to the scanning line; and a guide plate 53 arranged opposite these driving rollers 49 and 51 and thereby supporting the photosensitive material film 13. The guide plate 53 causes the photosensitive material film 13 inserted between itself and each of the driving rollers 49 and 51 to be bent along a part of the driving roller periphery surface on the outer side between these driving rollers arranged parallel, such that the driving rollers should contact the photosensitive material film 13, and retain an elastic repulsive force caused by the bending of the photosensitive material film 13.

This bending generates an elastic repulsive force in the photosensitive material film 13. The elastic repulsive force generates a predetermined frictional force between the photosensitive material film 13 and the driving rollers 49 and 51, so that a conveyance driving force is reliably transmitted from the driving rollers 49 and 51 to the photosensitive material film 13 so that the photosensitive material film 13 is conveyed. This reliably suppresses lift-up of the photosensitive material film 13 from the conveyance surface, that is, lift-up in the vertical direction. When laser light is projected onto the photosensitive material film 13 between these driving rollers, good recording can be performed without exposure position discrepancy. Here, the driving rollers 49 and 51 receive a driving force from driving section such as a motor (not shown) via transmission section such as gears and belts, and thereby revolve in the clockwise direction shown in FIG. 1.

Next, the thermal development section C is described below.

The thermal development section C is used for heating up a to-be-heat-treated heat developing recording material of a type to which heat treatment is applied. As for the configuration, a plurality of plate heaters 55, 57, and 59 serving as heating bodies reaching the temperature necessary for processing the photosensitive material film 13 and arranged in line in the transfer direction of the heat developing recording material are curved, while these plate heaters 55, 57, and 59 are arranged in the shape of a series of arcs.

That is, in the configuration of the thermal development section C including these plate heaters 55, 57, and 59, as shown in the figure, a concave surface is provided in each plate heater, while the photosensitive material film 13 contacts with and slides over the concave surfaces of the plate heaters, and thereby moves relatively. At that time, transferring section for the photosensitive material film 13 comprises: a feed roller 61; and a plurality of pressing rollers 63 serving also as members for heat transfer from the plate heaters to the photosensitive material film 13.

The pressing rollers 63 engage with a gear 65 and thereby revolve in a manner following the revolution of the gear 65. These pressing rollers 63 may be composed of metallic rollers, resin rollers, rubber rollers, or the like. According to this configuration, the conveyed photosensitive material film 13 is conveyed in a manner pressed against the plate heaters 55, 57, and 59. This prevents buckling of the photosensitive material film 13. Here, the above-mentioned curved plate heaters are an example. Alternatively, flat plate heaters, a heating drum, or the like may be employed as the heating section.

At the terminal end of the conveyance path of the photosensitive material film 13 within the thermal development section C, an ejection roller (pair) 67 for transferring the photosensitive material film 13 is arranged. Then, the photosensitive material film 13 conveyed from the thermal development section C is carefully cooled down in such a manner that wrinkles should not be generated by the cooling section D and that permanent warp should not arise. The photosensitive material film 13 ejected from the cooling section D is guided into a guide plate (pair) 71 by a cooling roller pair 69 provided in the middle of the conveyance path, and then ejected from an ejection roller pair 73 into the ejection tray 41. In the vicinity of the exit of the guide plate 71 a densitometer 29 serving as density measuring section is built in so that the recording density of the photosensitive material film 13 ejected from the cooling section D is measured, for example, in green light.

As such, in the cooling section D, a plurality of cooling roller pairs 69 are arranged such as to provide a desired fixed curvature R to the conveying path of the photosensitive material film 13. This indicates that the photosensitive material film 13 is conveyed in a state of fixed curvature R until being cooled down below the glass transition point of the material. As such, when a curvature is intentionally imparted to the photosensitive material film 13, it is prevented that excessive curling occurs before the photosensitive material film 13 is cooled down below the glass transition point. Then, when the temperature goes below the glass transition point, new curling does not occur, and hence the amount of curl does not vary.

Further, in the cooling section D, temperature control is performed for the cooling rollers themselves and the internal atmosphere. Such temperature control allows the state immediately after the start of the thermal treatment apparatus and the state after sufficient running to be similar as much as possible. This reduces density variation.

A sorter mechanism 75 is attached over the ejection tray 41. In the image forming apparatus 100, it is controllable that the photosensitive material film 13 conveyed from the guide plate 71 can be ejected selectively to the ejection tray 41 or the sorter mechanism 75. The sorter mechanism 75 can distribute arbitrarily the photosensitive material film 13 conveyed from the guide plate 71.

In the upside of the apparatus near the ejection tray 41, arranged are: a display section 77 for displaying the operation status of the image forming apparatus 100 and desired working instructions; and a data input section 78 used for inputting data to the image forming apparatus 100.

Next, a main control system of the image forming apparatus 100 is described below.

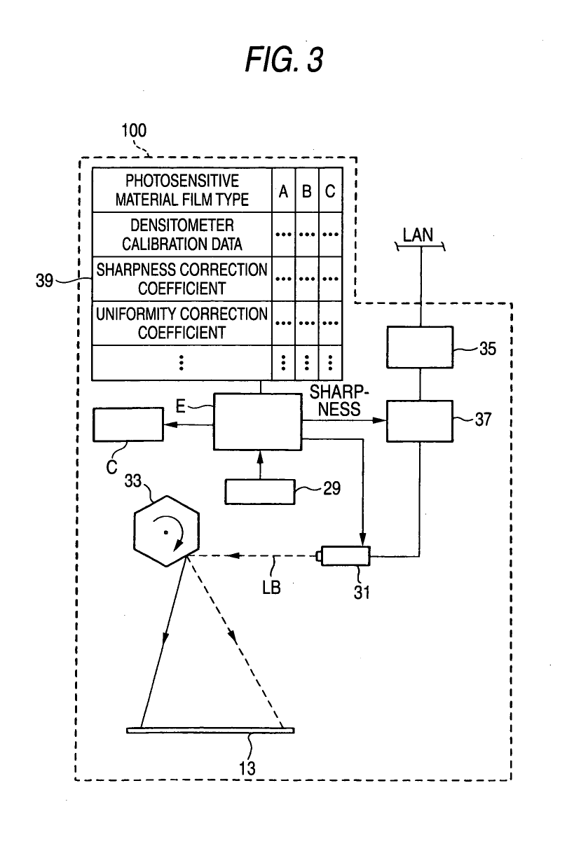

FIG. 3 is a block configuration diagram illustrated a control system of the image forming apparatus.

In the image forming apparatus 100, the power supply/control section E is turned ON by an ON operation of a starting switch SW arranged at a predetermined position.

The image forming apparatus 100 includes: a laser beam irradiation device 31; a polygon mirror 33 for scanning a laser beam LB projected from the laser beam irradiation device 31, on the photosensitive material film 13; an image data memory 35 connected to an image photographing apparatus (not shown) such as an MRI apparatus and an X-ray apparatus via a LAN (local area network) or the like and thereby acquiring and retaining image data transmitted from such an image photographing apparatus; and an image processing section 37 for extracting the image data stored in the image data memory 35, then performing image processing such as sharpness correction processing (frequency emphasis processing), then outputting the image data having undergone the image processing to the laser beam irradiation device 31, and thereby recording the image data onto the photosensitive material film 13.

In the image forming apparatus 100, the control section E controls the image processing section 37, performs output intensity correction for the laser beam irradiation device 31, and performs heating control in the thermal development section C. The control section E has a data memory 39 serving as storage section for storing various kinds of data.

The data memory 39 stores: calibration coefficient data for the densitometer 29; sharpness correction coefficient data applied in image sharpness correction performed in the image processing section 37; uniformity correction coefficient data applied in uniformity correction; various kinds of parameter values for density correction (e.g., density correction data); various kinds of parameter values for thermal development (e.g., heating data); and the like.

These calibration coefficient data, correction coefficient data, and parameter values have different values for each distinct photosensitive material film. Thus, the data memory 39 stores in advance these pieces of data corresponding to each of the types (three types A, B, and C in the example shown in FIG. 3) of the photosensitive material film 13 which can be used in the image forming apparatus 100.

Next, the operation of the image forming apparatus 100 having the above-mentioned configuration is described below.

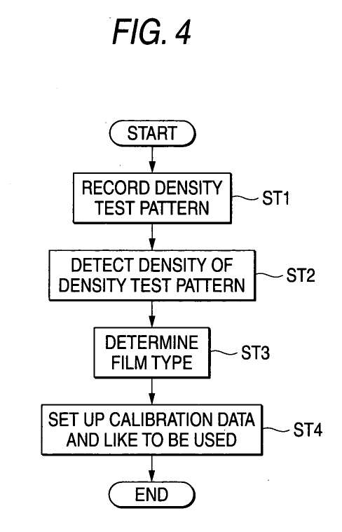

FIG. 4 is a flow chart showing an automatic film determination procedure performed by the control section when the photosensitive material film 13 is changed. FIG. 6 is a graph showing correlation between the density value and the exposure intensity for each photosensitive material.

First, the film magazine 24 for image forming apparatus is extracted from a desired loading section 15 or 17 of the image forming apparatus 100. Then, photosensitive material films 13 are loaded into the extracted film magazine 24 for image forming apparatus.

In the film magazine 24 for image forming apparatus, the lid member is opened, and then a film package 34 is placed inside the magazine body. At that time, the fin part 36 of the light shielding bag 30 is placed on a drawing roller (not shown) in the magazine body. Then, the lid member is closed. After the lid member is closed, the fin part 36 of the light shielding bag 30 is extracted from the drawing roller pair. As a result, the photosensitive material films 13 are left inside the film magazine 24 for the image forming apparatus in a state that the light shielding bag 30 is removed. As such, loading of the photosensitive material films 13 is completed.

When image formation processing is performed, a film extraction hole (not shown) of the lid member 85 is opened automatically, and then the photosensitive material film 13 loaded in the film magazine 24 for the image forming apparatus is extracted through the film extraction hole. The photo sensitive material film 13 is then conveyed toward the image exposure section B by the feed roller pair 21, then treated by the processing of exposure, development, and cooling, and then ejected to the ejection tray 41 or the sorter mechanism 75.

Here, the photosensitive material films are assumed to be there consisting of A film, B film, and C film, while A films are assumed to be accommodated in both of the trays 25 and 27. The photosensitive material films 13 would become exposed if opened to the outside light. Thus, in usage, distinct photosensitive material films 13 are not mixed within the same tray. That is, new photosensitive material films 13 contained in a light shielding bag 30 are loaded when the tray becomes empty.

When a user loads a new light shielding bag 30 into the uppermost tray 25 shown in FIG. 1 (the user need not know the new photosensitive material film, but B film is assumed in this example), the processing shown in FIG. 4 is performed in response to a predetermined key input operation.

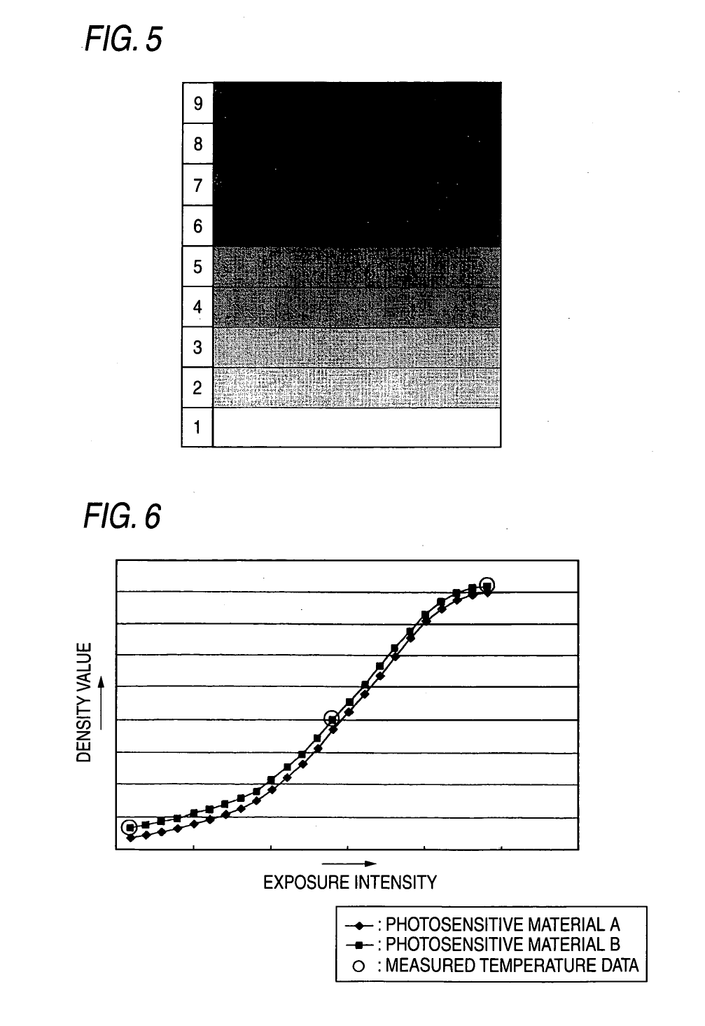

First, the control section E detects the film change performed in the uppermost tray 25, then extracts one sheet of the photosensitive material film 13 from the tray 25, and then conveys the sheet to the image exposure section B. Then, the control section E reads out, from the built-in memory (not shown), density test pattern data prepared in advance for the test, then outputs the pattern to the laser beam irradiation device (LD) 31, and thereby records the density test pattern onto the photosensitive material film 13 (st1). FIG. 5 shows a conceptual example of the density test pattern.

The photosensitive material film 13 is ejected from the image exposure section B to the cooling section D, and then passes through the built-in densitometer 29 so that the density of the density test pattern is measured by the densitometer 29 (st2). Then, the control section E acquires the density data measured by the densitometer 29, and there by determines the photosensitive material film 13 (st3).

Information employable for this determination includes: the necessary energies for the maximum density, the minimum density, and a specific density (film sensitivities); and the energy difference of a first specific density and a second specific density (inclination of the film sensitivity). Thus, the control section E determines the photosensitive material film 13 on the basis of at least one information piece (measurement value) selected from the above-mentioned ones or alternatively a combination of a plurality of the information pieces. In the present embodiment, at least the necessary energies for the maximum density, the minimum density, and a specific density are measured. As shown in FIG. 6, a photosensitive material is specified that has storage density data in agreement with the measurement density data.

Here, for example, when the measurement value of the maximum density or the minimum density is applied, determination becomes easy for a photo sensitive material film 13 having remarkable density characteristics at the maximum or minimum limit density. Further, when the necessary energy for the density is applied, determination becomes easy for a photosensitive material film 13 having remarkable density characteristics at medium density. Furthermore, when the energy difference between the first energy for a density and the second energy for a density is applied, determination becomes easy for a photosensitive material film 13 having remarkable density characteristics in a predetermined density range.

On the basis of the above-mentioned information, the control section E can determine that the photosensitive material film 13 is B film. Thus, various setting up is performed as follows (st4). That is, in subsequent image recording performed by using the photosensitive material films 13 in the uppermost tray 25, the measurement data of the densitometer 29 is calibrated by using the calibration coefficient data for B film. Further, the image processing section 37 performs sharpness correction by using the sharpness correction coefficient data for B film, while exposure value correction for the laser beam irradiation device 31 is performed on the basis of the uniformity correction coefficient data for B film. That is, inverted-correction is performed on the basis of the uniformity correction coefficient data for B film, and thereby line generated is removed from surface of B film. Furthermore, density correction is performed by applying the parameter value for B film, while heating control is performed in the thermal development section C on the basis of the heating parameter value for B film.

Here, when image recording is to be performed by using the photosensitive material film 13 in the tray 27, since A film is contained in the tray 27, the calibration coefficient data and the like for A film are applied. According to this method, even when the photosensitive material film is changed, appropriate correction processing is performed so that image recording with stable density is achieved.

As such, the image forming apparatus 100 of the present embodiment includes: the data memory 39 that stores the data corresponding to each photosensitive material film 13; the densitometer 29 that measures the density of the density test pattern; and control section E that determines the photosensitive material film 13 from the measurement value measured by the densitometer 29, and controls reading out data corresponding to the photosensitive material film 13 from the data memory 39, and then recording a target image onto the photosensitive material film 13. Accordingly, the image forming apparatus 100 can automatically determine the photosensitive material film 13 by means of the density test pattern recorded on the photosensitive material film 13. This avoids the time and effort that a user or a serviceman sets the photosensitive material film 13 into the image forming apparatus 100 at each time. Further, even when the photosensitive material film is changed, a high quality image can be obtained easily. Furthermore, an additional member such as bar code reading section is unnecessary. Thus, the photosensitive material film can be determined by a simple configuration.

The present application claims foreign priority based on Japanese Patent Application (JP 2005-134300) filed May 2 of 2005, the contents of which is hereby incorporated herein by reference.

What is claimed is:

1. An image forming apparatus for recording of a target image onto a photosensitive material film on the basis of a data corresponding to the photosensitive material film, comprising:
a storage section that stores the data corresponding to the photosensitive material film;
a density measuring section that measures a density of a density test pattern recorded on the photosensitive material film; and
a controlling section that controls recording the density test pattern onto the photosensitive material film, and determines the photosensitive material film on the basis of a measurement value of the density of the density test pattern, the measurement value measured by the density measuring section, and controls reading out the data corresponding to the photosensitive material film from the storage section, and then recording the target image onto the photosensitive material film.

2. The image forming apparatus according to claim 1, wherein the data corresponding to the photosensitive material film is at least one selected from:
a calibration coefficient data for the density measuring section;
a sharpness correction coefficient data to be applied when sharpness correction is performed on the target image;
a uniformity correction coefficient data to be applied when uniformity correction is performed on the target image;
a density correction data to be applied when density correction is performed on the target image; and
a heating data to be applied when thermal development is performed on the photosensitive material film in which the target image is recorded as a latent image.

3. The image forming apparatus according to claim 1, wherein the measurement value is at least one selected from:
a maximum density, a minimum density, a necessary energy for a density, and a energy difference between a first energy for a density and a second energy for a density, which are measured from the density test pattern by the density measuring section.
